(19) United States
(12) Patent Application Publication
(10) Pub. No.: US 2016/0026316 A1
(43) Pub. Date: Jan. 28, 2016

(54) METHOD AND DEVICE FOR MEASURING PRESSURE BASED ON TOUCH INPUT

(71) Applicant: SAMSUNG ELECTRONICS CO., LTD., Suwon-si (KR)

(72) Inventors: Hyun-soo CHOI, Seoul (KR); So-young KIM, Suwon-si (KR); Hyung-soon KIM, Goyang-si (KR); Ju-wan PARK, Seongnam-si (KR); Myung-sik KIM, Suwon-si (KR); Joon-oo KIM, Suwon-si (KR)

(73) Assignee: SAMSUNG ELECTRONICS CO., LTD., Suwon-si (KR)

(21) Appl. No.: 14/790,720

(22) Filed: Jul. 2, 2015

(30) Foreign Application Priority Data
Jul. 28, 2014 (KR) 10-2014-0096010

(51) Int. Cl. G06F 3/041; G09G 5/18

(52) U.S. Cl. CPC G06F 3/0414; G09G 5/18

(57) ABSTRACT

A device and method of measuring pressure on a device based on touch signals is provided. The method includes determining a reference pressure value of a grip of user on the device; obtaining first signals from a side detector of the device; obtaining second signals from a front detector of the device; and determining a level of pressure on the device by comparing the first signals and the second signals with the reference pressure value.

### CROSS-REFERENCE TO RELATED APPLICATION

This application claims the benefit of Korean Patent Application No. 10-2014-0096010, filed on Jul. 28, 2014, in the Korean Intellectual Property Office, the disclosure of which is incorporated y by reference herein in its entirety.

### BACKGROUND

1. Field

One or more exemplary embodiments relate to a method and device for measuring pressure on the device based on touch signals transmitted from detectors disposed on a side portion and a front portion of the device.

2. Description of the Related Art

Electronic devices provide various types of user interfaces, and a user controls operations of the electronic devices through the user interfaces and uses multiple functions of the electronic devices. Recently, as functions of the electronic devices have varied and sizes thereof have been reduced, touch screens are frequently used as input devices of the electronic devices. The touch screens have been widely used as input devices of the electronic devices, for example, portable terminals including cell phones such as smart phones, MP3 players, personal digital assistants (PDAs), portable multimedia players (PMPs), playstation portables (PSPs), portable game players, digital multimedia broadcasting (DMB) receivers, etc., monitors used in, for example, navigation devices, industrial terminals, laptop computers, banking automation machines, game players, etc., and house appliances such as refrigerators, microwave ovens, and washing machines.

Resistive touch sensors used in past touch phones are able to detect pressure and are delicately manipulated in narrow spaces. However, the resistive touch sensors may malfunction because touches are detected despite low pressures being applied. Also, there is a limitation on expanding usage scenarios because multiple touches are not supported. On the contrary, electrostatic (capacitive) touch sensors support multiple touches and detect touches more quickly and accurately than the resistive touch sensors. Thus, most smart phones that have been recently released include the electrostatic touch sensors.

In order to detect pressure that is not detected by the electrostatic touch sensors, research and development in electrostatic touch sensors, which are capable of detecting pressure, or the like have been conducted by changing the structures of the touch sensors. However, it is still difficult to use the electrostatic touch sensors in actual products because of several problems such as a thickness problem. When a pressure increase is determined by only using an increase in an area formed by the pressure in an electrostatic touch sensor, errors may easily occur. In an electrostatic touch sensor, in which two conductors overlap each other, a restoring force may degrade as the number of electrostatic touch sensor uses increases.

### SUMMARY

It is an aspect to provide a method and device for measuring pressure on the device by arranging touch sensors in a side portion and a front portion of the device, when a user grips the device.

Additional aspects will be set forth in part in the description which follows and, in part, will be apparent from the description, or may be learned by practice of the presented exemplary embodiments.

According to an aspect of one or more exemplary embodiments, there is provided a method of measuring pressure on a device, the method comprising determining a reference pressure value of a grip of user on the device; obtaining first signals from a side detector of the device; obtaining second signals from a front detector of the device; and determining a level of pressure on the device by comparing the first signals and the second signals with the reference pressure value.

The determining of the reference pressure value may comprise determining the reference pressure value when the user using the device grips the device by obtaining first reference signals from the side detector during a first reference period; obtaining second reference signals from the front detector during a second reference period; and determining the reference pressure value with respect to the user of the device, based on the obtained first reference signals and the obtained second reference signals.

The obtaining of the first signals may comprise obtaining a plurality of signals, from a plurality of sensors, respectively, comprised in the side detector, as the first signals, and the obtaining of the second signals may comprise obtaining second signals comprising touch signals, hovering signals, or a combination of the touch signals and the hovering signals which are input to a left edge and a right edge of the front detector of the device, as the second signals.

The determining of the reference pressure value may comprise setting a reference period; obtaining a plurality of first reference signals from the side detector of the device during the reference period; obtaining a plurality of second reference signals from the front detector of the device during the reference period; and determining the reference pressure value based on the plurality of first reference signals and the plurality of second reference signals.

The determining of the level of the pressure may comprise determining pressure patterns with respect to the device according to the first signals and the second signals by comparing the first signals and the second signals with the reference pressure value.

The determining of the level of the pressure may comprise determining a grip form in which the user grips the device, based on the reference pressure value, the first signals, and the second signals.

The method may further comprise determining a user input based on the determined level of the pressure; and performing operations corresponding to the determined the user input.

The determining of the level of the pressure may comprise determining pressure patterns with respect to the device by comparing the first signals and the second signals with the reference pressure value.

The method may further comprise obtaining an input manipulation signal for setting periods for obtaining the first signals and the second signals, wherein the first signals and the second signals are obtained during the periods that are set according to the input manipulation signal.

According to another aspect of one or more exemplary embodiments, there is provided a non-transitory computer-readable recording medium having embodied thereon a program, which when executed by a computer, for performing a method comprising determining a reference pressure value of a grip of user on the device; obtaining first signals from a side detector of the device; obtaining second signals from a front detector of the device; and determining a level of pressure on the device by comparing the first signals and the second signals with the reference pressure value.

According to another aspect of one or more exemplary embodiments, there is provided a device comprising a side detector arranged on a side portion of the device and configured to obtain first signals; a front detector arranged on a front portion of the device and configured to obtain second signals; and a controller configured to determine a reference pressure value of a grip of a user on the device and to determine a level of the pressure on the device by comparing the first signals and the second signals with the reference pressure value.

The side detector may be configured to obtain first reference signals during a first reference period, the front detector may be configured to obtain second reference signals during a second reference period, and the controller may be configured to determine of the reference pressure value with respect to the user using the device, based on the first reference signals and the second reference signals.

The side detector may comprise a plurality of sensors arranged on a left side portion and a right side portion of the device in an array form and configured to obtain a plurality of signals from the plurality of sensors, respectively, as the first signals, and the front detector may be configured to obtain a plurality of second signals comprising touch signals, hovering signals, or a combination of the touch signals and the hovering signals which are input to a left edge and a right edge of the device, as the second signals.

The side detector may be configured to obtain a plurality of first reference signals during a reference period, the front detector may be configured to obtain a plurality of second reference signals during the reference period, the device may further comprise a storage configured to store the plurality of first reference signals and the plurality of second reference signals, and the controller may be configured to set the reference period for determining the plurality of first reference signals and the plurality of second reference signals as references for determining the reference pressure value, and to determine the reference pressure value based on the plurality of first reference signals and the plurality of second reference signals, which are obtained during the reference period.

The controller may be configured to determine pressure patterns with respect to the device by comparing the first signals and the second signals with the reference pressure value.

The controller may be configured to determine a grip form in which the user grips the device, based on the reference pressure value, the first signals, and the second signals.

The controller may be further configured to determine a user input based on the determined level of the pressure on the device, and perform operations corresponding to the determined user input.

The controller may be configured to determine pressure patterns with respect to the device by comparing the first signals and the second signals with the reference pressure value.

The side detector or the front detector may be configured to obtain an input manipulation signal for setting a period for obtaining the first signals and the second signals.

The determining of the reference pressure value may comprise reading the reference pressure value from a storage.

The first reference period may be the same as the second reference period.

The controller may determine the reference pressure value by reading the reference pressure value from a storage.

According to another aspect of one or more exemplary embodiments, there is provided a method of controlling a device based on a grip pressure of a user on the device, the device comprising a plurality of pressure sensors, each sensor located at a different location on the device, the method comprising obtaining pressure signals from the plurality of pressure sensors during a time at which a user grips the device; comparing the pressure signals with a previously-set reference pressure signal associated with the user; controlling the device based on a result of the comparison.

Obtaining the pressure signals may comprise determining a grip form of the user, wherein the device is controlled based on the grip form.

Obtaining the pressure signals may comprise determining a pressure pattern of the grip of the user, wherein the device is controlled based on the pressure pattern.

### BRIEF DESCRIPTION OF THE DRAWINGS

The above and/or other aspects will become apparent and more readily appreciated from the following description of the exemplary embodiments, taken in conjunction with the accompanying drawings in which:

FIG. 1 is a block diagram of a structure of a device according to an exemplary embodiment;

FIGS. 2A to 2E illustrate a structure of a side detector of a device according to one or more exemplary embodiments;

FIGS. 3A and 3B illustrate a structure of a front detector of a device according to one or more exemplary embodiments;

FIG. 4 is a flowchart of a method of measuring pressure on a device, according to an exemplary embodiment;

FIGS. 5A to 5C are views for explaining a method of measuring pressure on a device, according to an exemplary embodiment;

FIG. 6 is a flowchart of a method of determining a reference pressure value as a pressure reference when a user of a device grips the device, according to an exemplary embodiment;

FIG. 7 is a view for explaining a method of determining a reference pressure value of a device, according to an exemplary embodiment;

FIG. 8 is a flowchart for explaining a method of controlling a device through gripping pressure of a user;

FIGS. 9A and 9B are views for explaining a method of controlling a device through gripping pressure; and

FIGS. 10A and 10B are views for explaining a method of controlling a device through gripping pressure.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein.

It will be further understood that the terms “comprises” and/or “comprising” used herein specify the presence of stated features or components, but do not preclude the presence or addition of one or more other features or components. Also, the terms “ . . . unit”, “ . . . module”, etc. are units for processing at least one function or operation and may be implemented as hardware, software, or a combination of hardware and software.

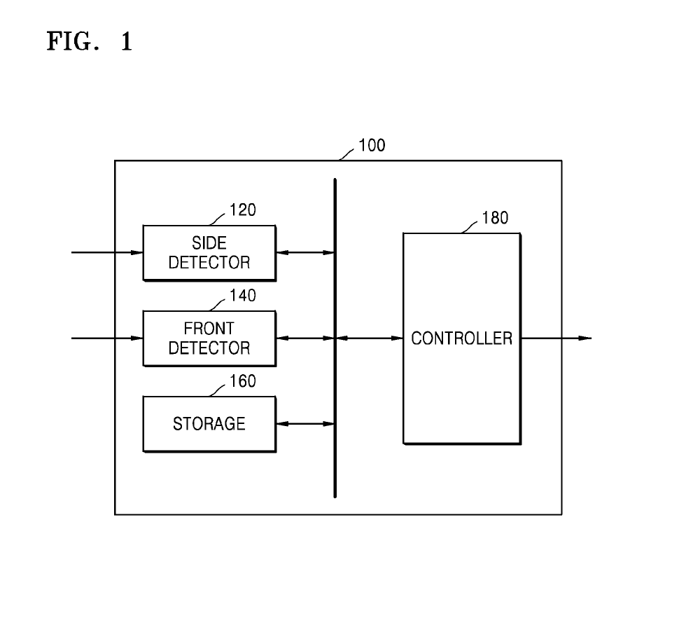

FIG. 1 is a block diagram of a structure of a device 100 for measuring pressure on the device 100 according to an exemplary embodiment.

The device 100 may be implemented in various forms. For example, the device 100 described in the present specification may be a mobile phone, a smart phone, a flexible display device, a laptop computer, a tablet PC, an e-book device, a digital broadcasting device, a personal digital assistant (PDA), a portable multimedia player (PMP), a navigation device, an MP3 player, a digital camera, or the like, but is not limited thereto.

The device 100 may include a side detector 120, a front detector 140, a storage 160, and a controller 180.

The side detector 120 may include a sensor disposed on a side portion of the device 100 and may be distinguished from the front detector 140 including a touch screen of the device 100. The side detector 120 may include an electrostatic touch sensor capable of detecting contacts of a user and intensities of the contacts when the user grips the device 100. However, the sensor included in the side detector 120 is not limited thereto and may be of various types. The side detector 120 may obtain first signals or first reference signals by detecting the contacts of a user and the intensities of the contacts, and may transmit the obtained first signals or first reference signals to the storage 160 or the controller 180.

The front detector 140 is a sensor disposed on a front portion of the device 100 and may include an electrostatic touch screen capable of detecting a touch or a hovering of a finger of the user when the user grips the device 100. A hovering occurs when, for example, a finger does not touch the touch screen but is held over the touch screen within a threshold distance of the touch screen. However, the sensor included in the front detector 140 is not limited thereto and may be of various types. The front detector 140 obtains second signals or second reference signals by detecting the touch or the hovering of the finger of the user when the user grips the device 100, and may transmit the second signals or the second reference signals to the storage 160 or the controller 180.

The side detector 120 and the front detector 140 may be distinguished from each other, but in a flexible display, both the side detector 120 and the front detector 140 may be included in one sensor module. For example, in a flexible display device, the side detector 120 and the front detector 140 may be included in a touch screen that is arranged on an entire portion of the flexible display.

The storage 160 may store all data relevant to the device 100. For example, the storage 160 may store signals obtained from the side detector 120 and the front detector 140.

The storage 160 may be implemented as at least one of storage media, for example, non-volatile memory such as cache, read only memory (ROM), programmable ROM (PROM), and electrically erasable programmable ROM (EPROM), volatile memory such as random access memory (RAM), a hard disk drive, etc., but is not limited thereto.

The controller 180 is configured to control overall operations of the device 100 and may include, for example, a central processing unit (CPU), but is not limited thereto.

The controller 180 determines a reference pressure value as a pressure reference when the user grips the device 100, based on the first reference signals and the second reference signals which are stored in the storage 160, and may determine a level of the pressure on the device 100 by comparing the determined reference pressure value with the first signals and the second signals respectively obtained from the side detector 120 and the front detector 140.

The controller 180 may determine various levels of pressure on the device 100 according to an intensity of pressure applied when the user grips the device 100 based on the reference pressure value, the first signals, and the second signals.

The controller 180 may determine pressure patterns generated on the device 100 according to grip motions of the user based on the reference pressure value, the first signals, and the second signals.

The controller 180 may determine a grip form in which the user grips the device 100 based on the reference pressure value, the first signals, and the second signals.

The controller 180 may determine the reference pressure value as a pressure reference when the user grips the device 100. For example, the controller 180 may obtain the first reference signals and the second reference signals from the storage 160 in order to determine the reference pressure value and may determine a reference pressure value with respect to the user using the device 100, based on the first reference signals and the second reference signals. The controller 180 may also store the determined reference pressure value in the storage 160 for later retrieval. Then, the controller 180 may determine the reference pressure value as the pressure reference at a later time by reading the reference pressure value from the storage 160.

In order to determine the reference pressure value with respect to the user using the device 100, the controller 180 may set a period during which some of the first reference signals and the second reference signals are extracted and may determine the reference pressure value based on the extracted first reference signals and second reference signals. The period may be predetermined.

The controller 180 may determine user inputs with respect to the device 100 based on a level of the pressure, pressure patterns, or a combination thereof, and may control the device 100 to perform operations in accordance with the user inputs

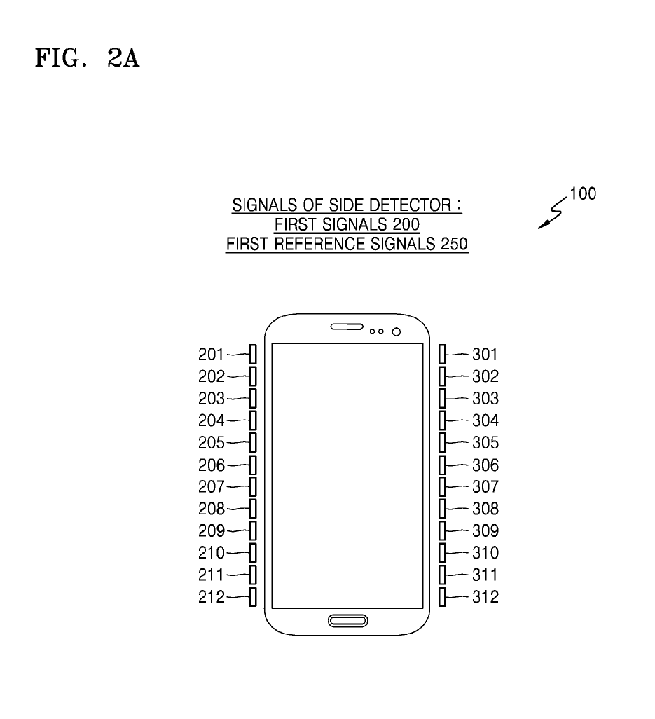

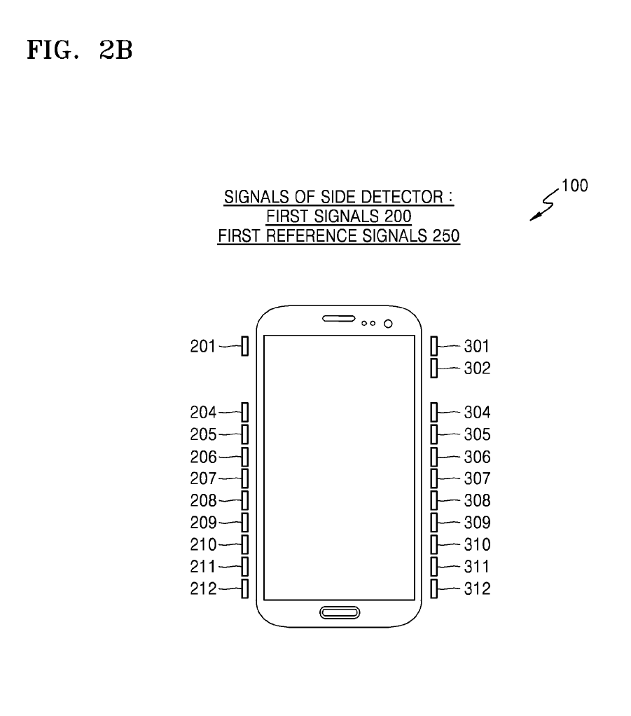

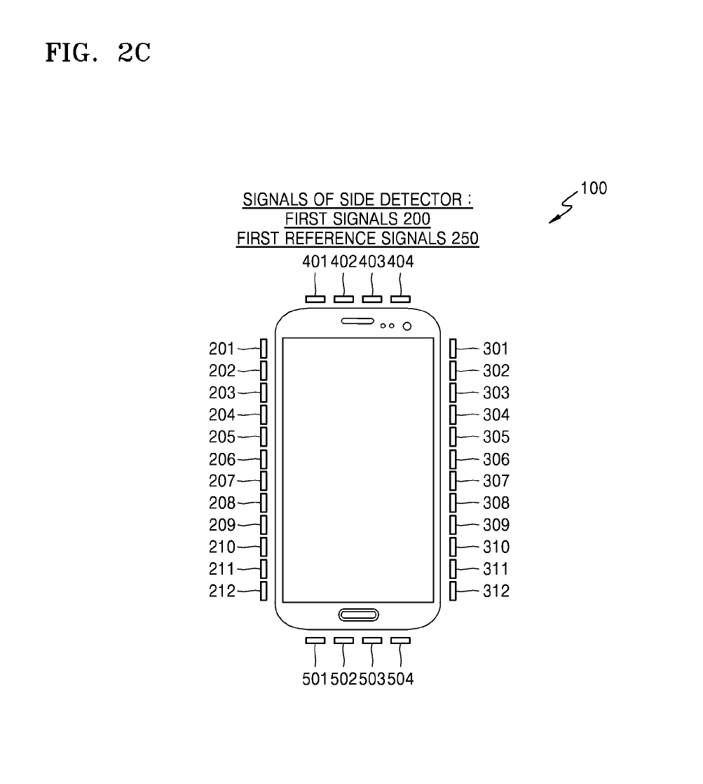

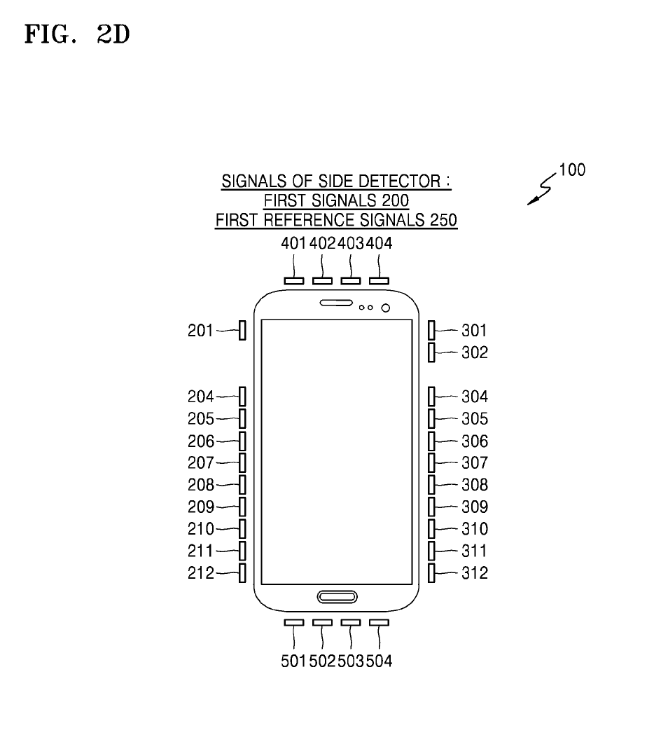

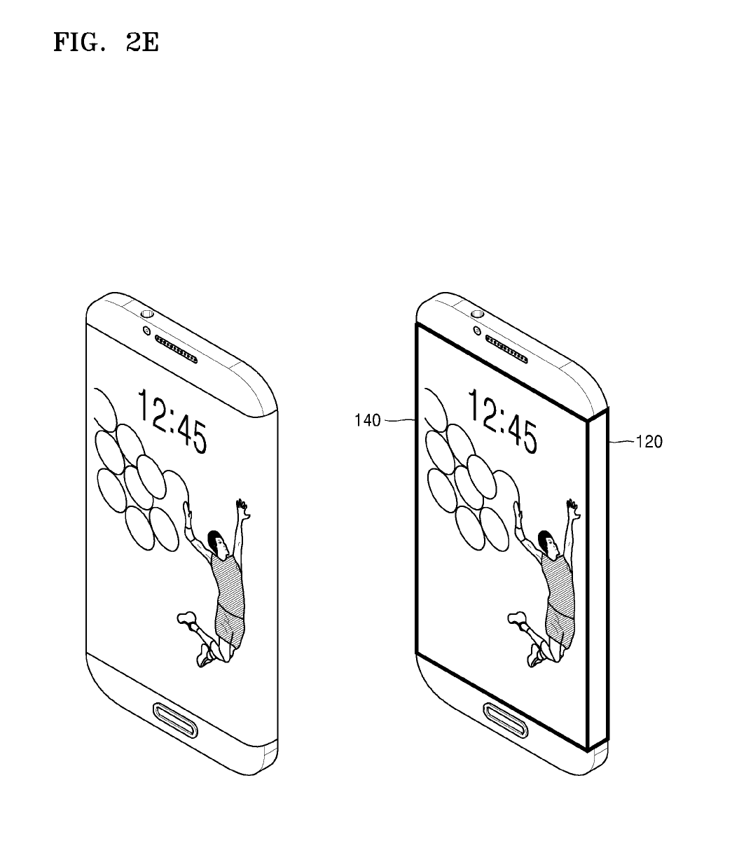

FIGS. 2A to 2E illustrate structures of the side detector 120 of the device 100 according to one or more exemplary embodiments.

Referring to FIGS. 2A and 2B, the side detector 120 may include a plurality of sensors that are arranged on a left side portion and a right side portion of the device 100 in an array form. For example, reference numerals 201 to 212 indicate sensors arranged on the left side portion of the device 100, and reference numerals 301 to 312 indicate sensors arranged on the right side portion of the device 100. The sensors may be symmetrically arranged on the left side portion and the right side portion of the device 100 in an array form. In some exemplary embodiments, the sensors may be arranged in the array form in portions except for portions where buttons are arranged, as shown in FIG. 2B. For example, FIG. 2B shows an exemplary embodiment in which three sensors, i.e., sensors 202, 203, and 303 are omitted in portions having buttons thereon. However, these arrangements are not limited thereto, and different distributions of sensors are contemplated.

Also, referring to FIGS. 2C and 2D, the side detector 120 may further include plurality of sensors that are arranged on an upper portion and a lower portion of the device 100 in an array form. For example, reference numerals 401 to 404 indicate sensors arranged on the upper portion of the device 100, and reference numerals 501 to 504 indicate sensors arranged on the lower portion of the device 100. As with FIG. 2B above, certain ones of the sensors 401 to 404 and/or 501 to 504 may be omitted in some exemplary embodiments. For example, certain ones of the sensors 401 to 404 and/or 501 to 504 may be omitted in portions having buttons thereon.

The side detector 120 may obtain first signals 200 that include a plurality of signals obtained from the sensors 201 to 212 and 301 to 312, which are arranged on the side portions of the device 100 in an array form. For example, the side detector 120 may measure contacts and intensities of the contacts of the sensors 201 to 212 and 301 to 312, which are arranged on the side portions of the device 100 in an array form and may obtain the first signals 200 by combining the signals with each other. The side detector 120 may transmit the obtained first signals 200 to the controller 180.

The side detector 120 may obtain first reference signals 250 including signals obtained from the sensors 201 to 212 and 301 to 312, which are arranged on the side portions of the device 100 in an array form. For example, the side detector 120 may measure and obtain contacts and intensities of the contacts of the sensors 201 to 212 and 301 to 312, which are arranged on the side portions of the device 100 in an array form and may obtain the first signals 200 by combining the signals with each other. Also, the side detector 120 may obtain the first reference signals 250 during a reference period. The reference period may be predetermined. The side detector 120 may transmit the first reference signals 250, which are obtained during the reference period, to the storage 160.

Also, referring to FIG. 2E, the side detector 120 may be a capacitive touch screen. For example, in a flexible display device, the side detector 120 is a part of the flexible display device and may be arranged on a side portion of the flexible display device, and the front detector 140 is also a part of the flexible display device and may be arranged on a front portion of the flexible display device.

The side detector 120 may obtain touch signals and hovering signals, which are generated by a grip of the user, as the first signals 200. The side detector 120 may detect direct contacts of the user. The side detector 120 may also detect the hovering signals. A hovering signal is generated occurs when, for example, a finger or other part of the body of the user does not touch the touch screen directly but is held over the touch screen within a threshold distance of the touch screen. For example, the side detector 120 measures intensities of signals according to areas where the touch signals and the hovering signals, which are generated by the grip of the user, are detected and may obtain the first signals 200 or the first reference signals 250.

The side detector 120 may transmit the obtained first signals 200 to the controller 180. Also, the side detector 120 may obtain the first reference signals 250 during a reference period and may transmit the first reference signals 250, which are obtained during the reference period, to the storage 160. The reference period may be predetermined.

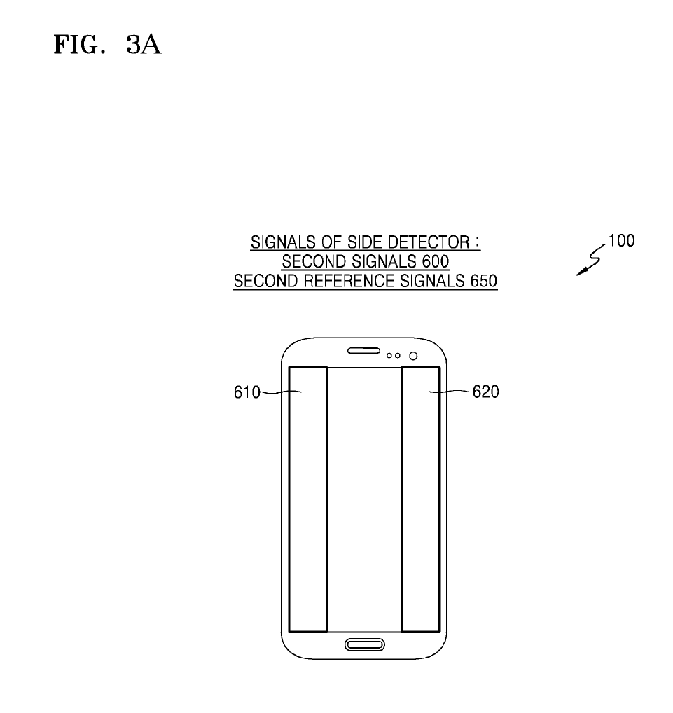

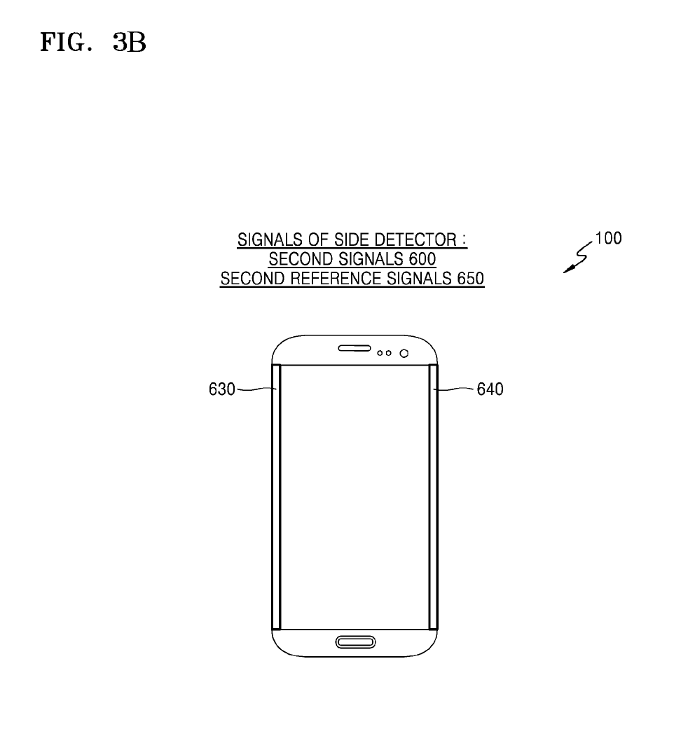

FIGS. 3A and 3B illustrate structures of the front detector 140 of the device 100 according to one or more exemplary embodiments.

Referring to FIG. 3A, the front detector 140 may include sensors arranged on a front left edge 610 and a front right edge 620 of the device 100. For example, the front detector 140 may obtain the touch signals and the hovering signals, which are generated by the grip of the user, as second signals 600. The front detector 140 may detect direct contacts of the user, or a hovering of the user. A hovering of the user occurs when, for example, a finger or other part of the body of the user does not touch the touch screen directly but is held over the touch screen within a threshold distance of the touch screen. For example, the front detector 140 measures intensities of the signals according to areas where the touch signals or the hovering signals are detected, and may obtain the second signals 600.

Referring to FIG. 3B, the front detector 140 may further include a left bezel 630 and a right bezel 640 of the device 100 in addition to the sensors arranged on the front left edge 610 and the front right edge 620 of the device 100.

The front detector 140 may transmit the obtained second signals 600 to the controller 180. Also, the front detector 140 may obtain second reference signals 650 during a reference period and may transmit the second reference signals 650, which are obtained during the reference period, to the storage 160. The reference period may be predetermined.

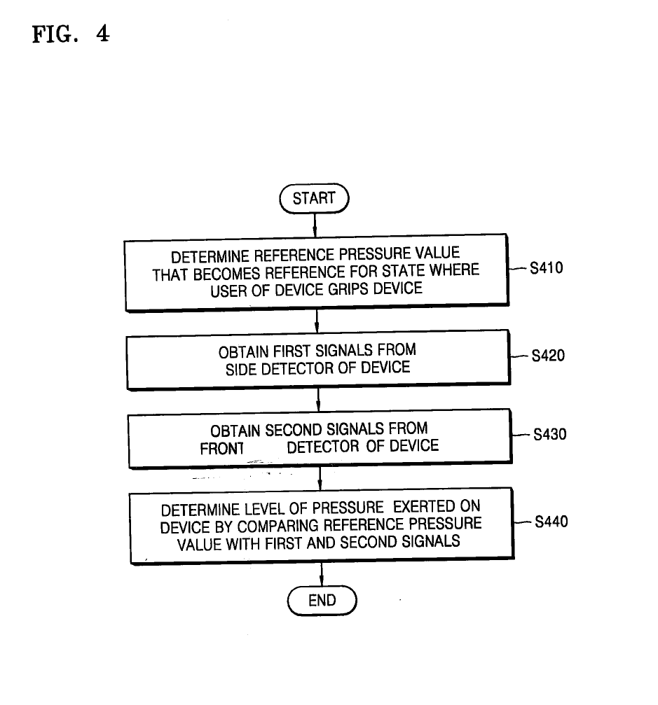

FIG. 4 is a flowchart of a method of measuring pressure on the device 100, according to an exemplary embodiment.

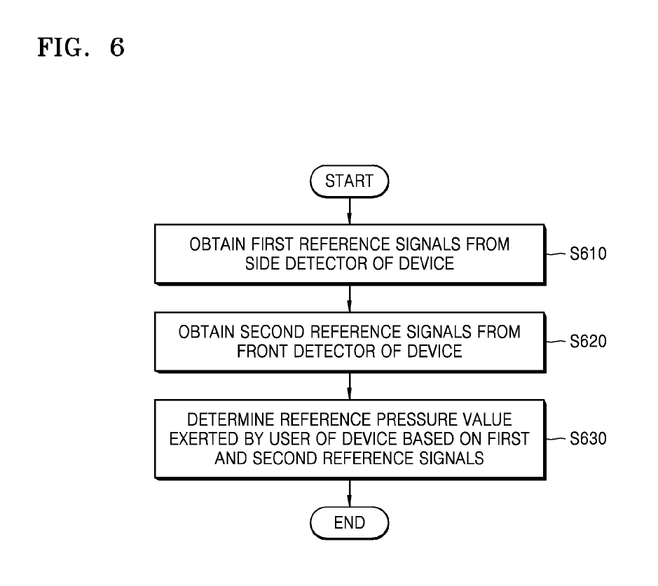

When the user grips the device 100 in operation S410, the device 100 determines a reference pressure value as a pressure reference when the user grips the device 100. The reference pressure value may be determined “on the fly” at the time the user grips the device 100 according to the method described below with reference to FIG. 6, or the reference pressure value may be determined by reading a previously stored reference pressure value from the storage 160.

In operation S420, the device 100 obtains the first signals 200 from the side detector 120 arranged on the side portion of the device 100.

In operation S430, the device 100 obtains the second signals 600 from the front detector 140 arranged on the front portion of the device 100.

In operation S440, the device 100 determines a level of the pressure on the device 100 by comparing the determined reference pressure value with the first signals 200 and the second signals 600.

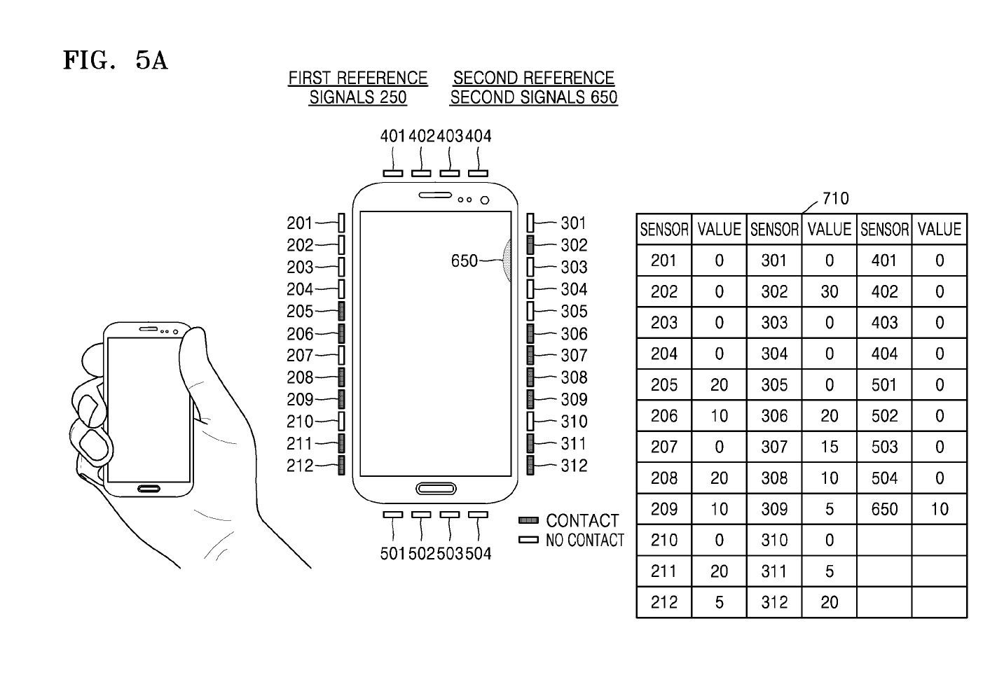

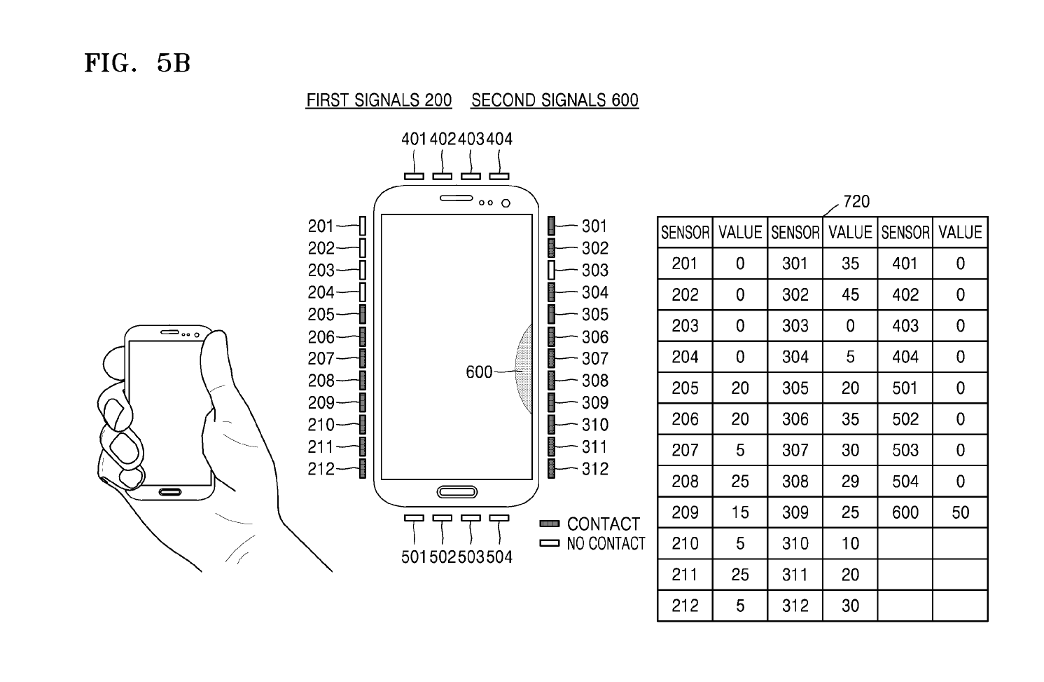

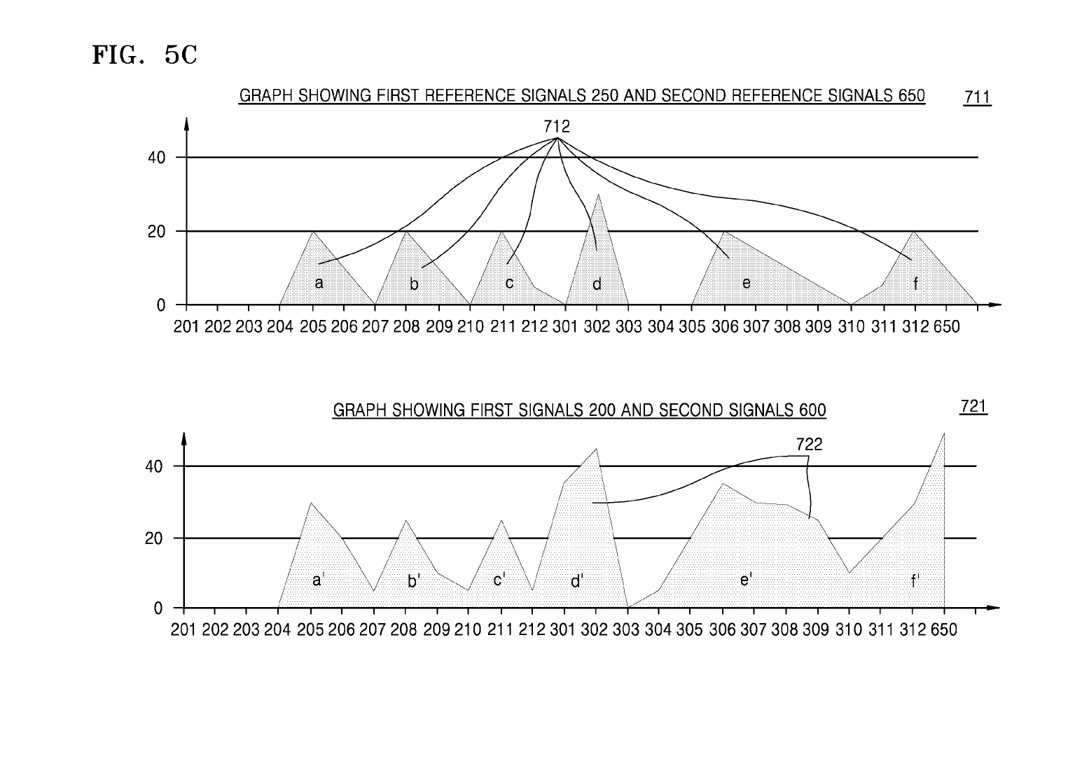

FIGS. 5A to 5C are views for explaining a method of measuring the pressure on the device 100, according to an exemplary embodiment.

FIG. 5A is a view for explaining a method of determining the reference pressure value in the device 100, according to an exemplary embodiment.

Referring to FIG. 5A, when the user grips the device 100, the device 100 may obtain the first reference signals 250 during a reference period through the side detector 120 of the device 100. For example, the device 100 may obtain signals by measuring direct contacts and/or hoverings of respective sensors and intensities of the contacts and/or hoverings from the sensors 201 to 212 and 301 to 312 included in the side detector 120 and may obtain the first reference signals 250 by combining the signals with each other.

Also, the device 100 may obtain the second reference signals 650 during the reference period through the front detector 140. For example, the device 100 may measure intensities of the second reference signals 650 in accordance with areas where the touch and hovering are detected by the front detector 140 and may obtain the second reference signals 650.

The device 100 may store data 710 including the first reference signals 250 and the second reference signals 650 in the storage 160 in order to determine the reference pressure value as a pressure reference when the user grips the device 100, based on the first reference signals 250 and the second reference signals 650, which are obtained during the reference period.

For example, a value of the first reference signal 250 obtained from the sensor 206 that the user contacts is equal to “10” and may be recorded in the data 710 including the first reference signals 250 and the second reference signals 650. A value of the first reference signal 250 obtained from the sensor 305 that the user does not contact is equal to “0” and may be recorded in the data 710 including the first reference signals 250 and the second reference signals 650.

FIG. 5B is a view for explaining a method of measuring the pressure on the device 100, according to an exemplary embodiment.

Referring to FIG. 5B, when the user applies pressure to the device 100, the device 100 may obtain the first signals 200 through the side detector 120. For example, the device 100 may obtain signals by measuring the contacts and/or hoverings of respective sensors and intensities of the contacts and/or hoverings from the sensors 201 to 212 and 301 to 312 included in the side detector 120 and may obtain the first signals 200 by combining the signals with each other.

Also, the device 100 may obtain the second signals 600 through the front detector 140. For example, the device 100 measures intensities of the signals in accordance with the areas, where the touch and hovering signals are detected, through the front detector 140 and may obtain the second signals 600.

The device 100 may transmit data 720 including the first signals 200 and the second signals 600 to the controller 180 in order to determine a level of the pressure on the device 100 based on the first signals 200 and the second signals 600.

For example, a value of the first reference signal 250 obtained from the sensor 206 that the user contacts is equal to “20”, may be written in the data 720 including the first signals 200 and the second signals 600, and then may be transmitted to the controller 180. A value of the first reference signal 250 obtained from the sensor 605 that the user does not contact is equal to “0”, may be written in the data 720 including the first signals 200 and the second signals 600, and then may be transmitted to the controller 180. It should be noted that the device 100 may obtain the first signals 200 and the second signals 600 immediately after obtaining the first reference signals 250 and the second reference signals 650, or may obtain the first signals 200 and the second signals 600 at a later time. For example, the device 100 may obtain the first reference signals 250 and the second reference signals 650 and store the obtained reference signals when a user grips the device 100. Then, after the user has set down the device 100 and picked up the device 100 again and re-grips the device 100, the device 100 may obtain the first signals 200 and the second signals 600.

FIG. 5C are graphs for explaining a method of determining a level of pressure on the device 100.

In some exemplary embodiments, the device 100 determines the reference pressure value based on the data 710 including the first reference signals 250 and the second reference signals 650, which is stored in the storage 160, and may determine the level of pressure on the device 100 by comparing the reference pressure value with the data 720 including the first signals 200 and the second signals 600 which are respectively obtained from the side detector 120 and the front detector 140. For example, the reference pressure value may be compared with the first signals 200 and the second signals 600 by using graphs.

FIG. 5C shows a graph 711 showing the first reference signals 250 and the second reference signals 650 which form the reference pressure value and a graph 721 showing the first signals 200 and the second signals 600.

An X axis of the graph 711 indicates sensors included in the side detector 120 and the front detector 140, and a Y axis of the graph 711 indicates values of signals received from the sensors. The values correspond to values of the first reference signals 250 and the second reference signals 650 forming the reference pressure value. Also, an X axis of the graph 721 indicates sensors included in the side detector 120 and the front detector 140, and a Y axis of the graph 721 indicates values of signals received from the sensors, that is, values of the first signals 200 and the second signals 600. The values of the signals may indicate a pressure intensity generated when the user grips the device 100.

For example, a value of the first reference signal 250 obtained from the sensor 206 is equal to “10” and may be indicated on the graph 711. A value of the first signal 200 obtained from the sensor 206 is equal to “20” and may be indicated on the graph 721. The values of the signals indicated on the Y axes of the graphs 711 and 721 may be in units indicating an intensity of pressure that is measured as the user grips the device 100. The units may be predetermined, and the intensity of pressure may be normalized in some exemplary embodiments.

For example, the level of pressure on the device 100 may be determined by comparing an area 712, which is formed by the X axis of the graph 711 and a reference pressure value 730, on the graph 711 indicating the reference pressure value, with an area 722, which is formed by the X axis of the graph 721 and the values of the first signals 200 and the second signals 600, on the graph 721 indicating the first signals 200 and the second signals 600. For example, the area 712 may be a sum of the areas of portions a, b, c, d, e, and f, and the area 722 may be a sum of the areas of portions a′, b′, c′, d′, e′, and f.

For example, when the area 722, which is formed by the X axis of the graph 721 and the first signals 200 and the second signals 600, is greater than the area 712, which is formed by the X axis of the graph 711 and the reference pressure value, the device 100 may determine that the pressure on the device 100 is great. When the area 722, which is formed by the X axis of the graph 721 and the first signals 200 and the second signals 600, is smaller than the area 712, which is formed by the X axis of the graph 711 and the reference pressure value, the device 100 may determine that the pressure on the device 100 is small. In other words, the area 722 of the graph 721 may be used as a threshold reference pressure value, such that when the area 712 of the graph 711 is greater than the threshold reference pressure value, the pressure value is high, and when the area 712 of the graph 711 is less than or equal to the threshold reference pressure value, the pressure value is low.

When the user grips the device 100, the method of determining the level of pressure on the device 100 is not limited thereto and may vary.

In some exemplary embodiments, the device 100 may determine various levels of pressure on the device 100 in accordance with intensities measured when the user grips the device 100.

For example, the device 100 calculates a difference between the area 712, which is formed by the X axis of the graph 711 and the reference pressure value on the graph 711 indicating the reference pressure value, and the area 722, which is formed by the X axis of the graph 721 and the first signals 200 and the second signals 600 on the graph 721 indicating the first signals 200 and the second signals 600, and may determine various levels of pressure on the device 100 by comparing the calculated difference with the area 712, which is formed by the X axis of the graph 711 and the reference pressure value. In other words, the device 100 may determine a level of the pressure on the device 100 depending on how large or how small the difference is from the reference pressure value.

In some exemplary embodiments, when a ratio of the above difference to the area 712, which is formed by the X axis of the graph 711 and the reference pressure value, is less than a first threshold value, the device 100 may determine that the pressure on the device 100 has a first pressure level. Also, when a ratio of the above difference to the area 712, which is formed by the X axis of the graph 711 and the reference pressure value, is greater than the first threshold value, the device 100 may determine that the pressure on the device 100 has a second pressure level.

In some exemplary embodiments, when the area 722, which is formed by the X axis of the graph 721 and the first signal 200 and the second signals 600, is greater than the area 712, which is formed by the X axis of the graph 711 and the reference pressure value, and when the ratio of the difference between the area 722, which is formed by the X axis of the graph 721 and the first signal 200 and the second signals 600, and the area 712, which is formed by the X axis of the graph 711 and the reference pressure value, to the area 712 is smaller than the first threshold value, the device 100 may determine that the level of pressure on the device 100 is a first high pressure.

Also, when the area 722, which is formed by the X axis of the graph 721 and the first signal 200 and the second signals 600, is smaller than the area 712, which is formed by the X axis of the graph 711 and the reference pressure value, and when the ratio of the difference between the area 722, which is formed by the X axis of the graph 721 and the first signal 200 and the second signals 600, and the area 712, which is formed by the X axis of the graph 711 and the reference pressure value, to the area 712 is smaller than the first threshold value, the device 100 may determine that the level of pressure on the device 100 is a first low pressure.

In some exemplary embodiments, when the area 722, which is formed by the X axis of the graph 721 and the first signal 200 and the second signals 600, is greater than the area 712, which is formed by the X axis of the graph 711 and the reference pressure value, and when the ratio of the difference between the area 722, which is formed by the X axis of the graph 721 and the first signal 200 and the second signals 600, and the area 712, which is formed by the X axis of the graph 711 and the reference pressure value, to the area 712 is greater than the first threshold value, the device 100 may determine that the level of pressure on the device 100 is a second high pressure.

Also, when the area 722, which is formed by the X axis of the graph 721 and the first signal 200 and the second signals 600, is smaller than the area 712, which is formed by the X axis of the graph 711 and the reference pressure value, and when the ratio of the difference between the area 722, which is formed by the X axis of the graph 721 and the first signal 200 and the second signals 600, and the area 712, which is formed by the X axis of the graph 711 and the reference pressure value, to the area 712 is greater than a second threshold value, the device 100 may determine that the level of pressure on the device 100 is a second low pressure.

In some exemplary embodiments, an area of the first signals 200 and/or the second signals 600 corresponding to a block of sensors may be compared to an area of the first reference signals 250 and/or the second reference signals 650 corresponding to the block of sensors. For example, the area a of the graph 711 may be compared to the area a′ of the graph 721, or the area a and f of the graph 711 may be compared to the area a′ and f of the graph 721.

Methods of determining the levels of pressure on the device 100 according to the intensities that are measured when the user grips the device 100 are not limited thereto and may vary.

In some exemplary embodiments, the device 100 may determine patterns of pressure on the device 100 according to grip motions of the user.

For example, the device 100 obtains the first signals 200 from the side detector 120 arranged on the side portion of the device 100 during a reference period and may obtain the second signals 600 from the front detector 140 arranged on the front portion of the device 100 during the reference period. Also, by comparing the reference pressure value with the first signals 200 and/or the second signals 600, the device 100 may determine levels of pressure on the device 100, depending on each first signal 200 and each second signal 600 from among the first signals 200 and the second signals 600. Also, the device 100 may determine the patterns of pressure on the device 100 according to the grip motions of the user by combining results of determining the levels of pressure, depending on each of the first signals 200 and the second signals 600.

For example, the device 100 obtains five first signals 200 from the side detector 120 during the reference period and may obtain five second signals 600 from the front detector 140 during the reference period. Also, the device 100 may obtain five results of determining the levels of pressure by comparing the five first signals 200 with the five second signals 600. For example, the device 100 may sequentially obtain the results of determining the levels of pressure as “a first high pressure, a second low great pressure, a first high pressure, a first low pressure, and a first high pressure”, and the device 100 may determine the five results as the patterns of pressure on the device 100.

A method of determining the patterns of pressure on the device 100 according to the grip motions of the user is not limited thereto and may vary.

In some exemplary embodiments, the device 100 may determine a grip form in which the user grips the device 100.

For example, the device 100 may determine a grip form such as a right hand grip, or a left hand grip as the user grips the device 100. Types of the grip form are not limited thereto and may vary.

For example, the device 100 obtains the first reference signals 250 and the second reference signals 650 from the side detector 120 and the front detector 140, respectively, and may determine the reference pressure value as a pressure reference when the user grips the device 100. The device 100 obtains the first signals 200 and the second signals 600 from the side detector 120 and the front detector 140 and may determine a grip form in which the user grips the device 100, based on the reference pressure value, the first signals 200, and the second signals 600.

For example, the device 100 compares signals, which are obtained from the sensors 201 to 212 arranged on the left side portion of the side detector 120, with signals, which are obtained from the sensors 301 to 312 arranged on the right side portion of the side detector 120, from among signals forming the reference pressure value, compares signals, which are obtained from the sensors 201 to 212 arranged on the left side portion of the side detector 120, with signals, which are obtained from the sensors 301 to 312 arranged on the right side portion of the side detector 120, from among signals forming the first signals 200, and compares signals obtained from the front left edge 610 of the front detector 140 with signals obtained from the front right edge 620 of the front detector 140 from among signals forming the second signals 600, thereby determining a grip form of the user.

For example, when a sum of the signals, which are obtained from the sensors 201 to 212 arranged on the left side portion of the side detector 120, is greater than a sum of the signals, which are obtained from the sensors 301 to 312 arranged on the right side portion of the side detector 120, from among the signals forming the reference pressure value, when a sum of the signals, which are obtained from the sensors 201 to 212 arranged on the left side portion of the side detector 120, is greater than a sum of the signals, which are obtained from the sensors 301 to 312 arranged on the right side portion of the side detector 120, from among the signals forming the first signals 200, and when a sum of intensities of the signals obtained from the front left edge 610 of the front detector 140 is greater than a sum of intensities of the signals obtained from the front right edge 620 of the front detector 140, the device 100 may determine that a grip form of the user is a left-hand grip form.

On the other hand, when a sum of the signals, which are obtained from the sensors 201 to 212 arranged on the left side portion of the side detector 120, is smaller than a sum of the signals, which are obtained from the sensors 301 to 312 arranged on the right side portion of the side detector 120, from among the signals forming the reference pressure value, when a sum of the signals, which are obtained from the sensors 201 to 212 arranged on the left side portion of the side detector 120, is smaller than a sum of the signals, which are obtained from the sensors 301 to 312 arranged on the right side portion of the side detector 120, from among the signals forming the first signals 200, and when a sum of intensities of the signals obtained from the front left edge 610 of the front detector 140 is smaller than a sum of intensities of the signals obtained from the front right edge 620 of the front detector 140, the device 100 may determine that a grip form of the user is a right-hand grip form.

Also, when comparison results are different from the above description, the device 100 may determine that the grip form of the user is indeterminate.

The method of determining the grip form of the user is not limited thereto and may vary.

FIG. 6 is a flowchart of a method of determining a reference pressure value as a pressure reference when a user of the device 100 grips the device 100, according to an exemplary embodiment.

In operation S610, the device 100 may obtain the first reference signals 250 from the side detector 120 arranged on the side portion of the device 100.

In some exemplary embodiments, the device 100 may obtain the first reference signals 250 from the side detector 120 during a first reference period. The reference period may be predetermined.

In operation S620, the device 100 may obtain the second reference signals 650 from the front detector 140 arranged on the front portion of the device 100.

In some exemplary embodiments, the device 100 may obtain the second reference signals 650 from the front detector 140 during a second reference period. The second reference period may be predetermined. The second reference period may be the same as or different from the first reference period.

The device 100 may set the first reference period and/or the second reference period, during which some of the first reference signals 250 and/or the second reference signals 650 are to be extracted, in order to determine the reference pressure value. For example, the first reference period and/or the second reference period may be five seconds during which five first reference signals 250 and five second reference signals 650 may be extracted. However, this is only an example, and the reference periods may be set for seconds, several days, or several months, but are not limited thereto.

Also, the user may set the first reference period and/or the second reference period on the device 100 through a user interface. For example, the user may select the first reference period and/or the second reference period as several seconds, several days, or several months on the device 100, and the device 100 may obtain the first reference signals 250 and/or the second reference signals 650 during the first reference period and/or the second reference period and may extract the first reference signals 250 and/or the second reference signals 650 of the first reference period and/or the second reference period, from among the obtained first reference signals 250 and second reference signals 650.

The device 100 may provide the user interface including a setting screen for receiving the first reference period and/or the second reference period from the user and may receive the first reference period and/or the second reference period d from the user through the user interface.

For example, the device 100 may extract signals received from the side detector 120 and the front detector 140 of the device 100 ‘from the point in time when the device 100 is initialized to the present time’ as signals for determining the reference pressure value. Also, for example, the device 100 may extract the signals received from the side detector 120 and the front detector 140 of the device 100 ‘from the point in time when the device 100 is activated to the present time’ as the signals for determining the reference pressure value.

In detail, when the user sets the first reference period and/or the second reference period to a ‘period from the point in time when the device 100 is initialized to the present time’ through the user interface including the setting screen, the device 100 may extract the signals, which are received from the side detector 120 and the front detector 140 of the device 100 from the point in time when the device 100 is initialized until the user sets the first reference period and/or the second reference period through the user interface, as signals for determining the reference pressure value. Also, when the user sets the first reference period and/or the second reference period to a period ‘from the point in time when the device 100 is activated to the present time’, the device 100 may extract the signals, which are received from the side detector 120 and the front detector 140 of the device 100 from the point in time when the device 100 is activated until the device 100 user sets the first reference period and/or the second reference period through the user interface, as the signals for determining the reference pressure value. For example, the device 100 may set the ‘period from the point in time when the device 100 is initialized to the present time’ as a default value when the user does not set the first reference period and/or the second reference period through the user interface.

The device 100 may provide the user interface including a setting button for receiving a setting regarding the first reference period and/or the second reference period from the user, and the user may set the first reference period and/or the second reference period on the device 100 through the user interface. The setting button may be a touch button or a hovering button shown on a touch screen of the device 100, an actual button, or a combination thereof. However, the setting button is not limited thereto and may be implemented in various forms.

For example, the device 100 may receive a user input through the user interface including the setting button and may extract signals, which are received from the side detector 120 and the front detector 140 of the device 100 ‘for several seconds (e.g., five seconds) from the point in time when the user input is received’, as the signals for determining the reference pressure value. For example, when the user pushes the setting button and thus, the device 100 receives the user input, the device 100 may extract the signals, which are received from the side detector 120 and the front detector 140 of the device 100 ‘for five seconds from the point in time when the user input is received’, as the signals for determining the reference pressure value.

Also, the device 100 may receive user inputs that determines start and end points of the first reference period and/or the second reference period through the user interface including the setting button and may extract signals, which are received from the side detector 120 and the front detector 140 of the device 100 from a point in time when a first user input is received to a point in time when a second user input is received′, as the signals for determining the reference pressure value. For example, when the device 100 receives the first user input after the user pushes the setting button and when the device 100 receives the second user input after the user pushes the setting button again after 10 seconds, the device 100 may extract the signals, which are received from the side detector 120 and the front detector 140 of the device 100 from a point in time when a first user input is received to a point in time when a second user input is received′, as the signals for determining the reference pressure value. That is, the device 100 may extract the signals for the 10 seconds between the first and second user inputs.

In operation S630, the device 100 may determine the reference pressure value with respect to the device 100 based on the first reference signals 250 and the second reference signals 650 during the reference period.

The device 100 may determine the reference pressure value based on the first reference signals 250 and the second reference signals 650 which are obtained from the side detector 120 and the front detector 140 during the first reference period and/or the second reference period and may determine the reference pressure value based on the first reference signals 250 and the second reference signals 650 which are extracted during the first reference period and/or the second reference period from among the obtained first reference signals 250 and the second reference signals 650.

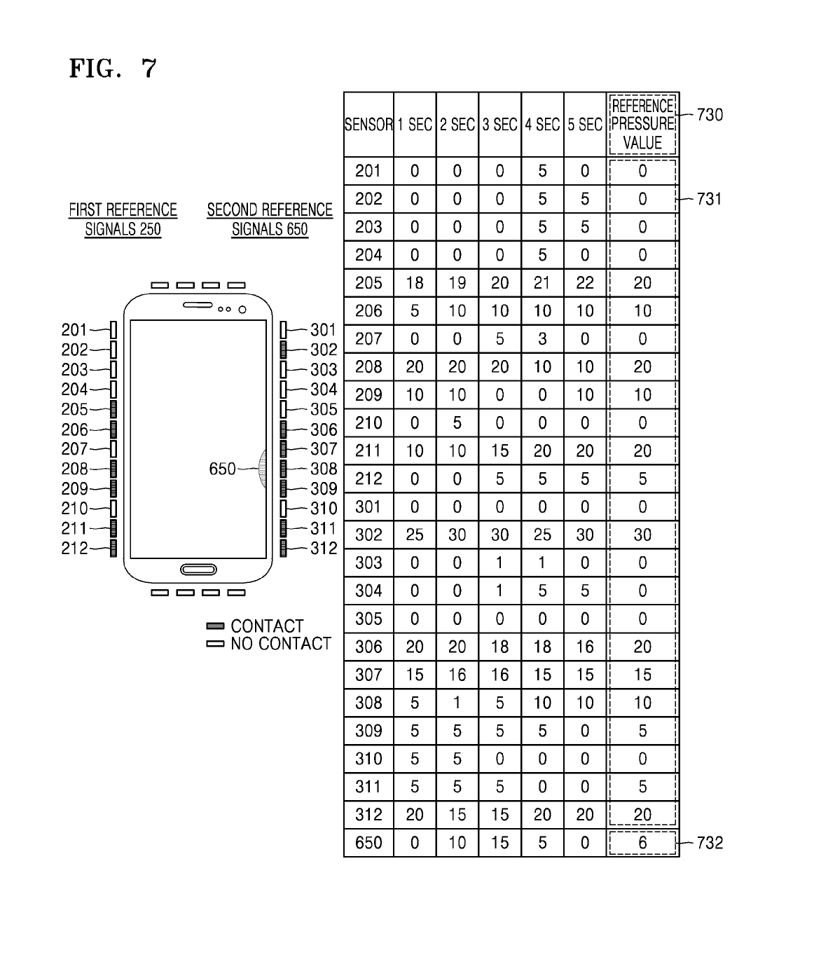

FIG. 7 is a view for explaining a method of determining a reference pressure value of the device 100, according to an exemplary embodiment.

FIG. 7 is a view for explaining a method of determining a reference pressure value 730 as a pressure reference when the user grips the device 100, according to an exemplary embodiment.

Referring to FIG. 7, the device 100 may obtain the first reference signals 250 from the side detector 120 arranged on the side portion of the device 100. In this case, the device 100 may obtain the first reference signals 250 from the side detector 120 and may set a period for extracting some of the first reference signals 250. For example, five of the first reference signals 250 may be extracted per second by setting the period, that is, five seconds, and a reference pressure value 731 of the first reference signals 250 of the device 100 may be determined by using the extracted first reference signals 250. The period may be predetermined.

For example, the device 100 may extract five signals having values of “18, 19, 20, 21, and 22” from among signals obtained by the sensor 205 included in the side detector 120.

Also, the device 100 may determine the reference pressure value 731 of the first reference signals 250 based on the extracted signals. For example, the device 100 determines a mode as the reference pressure value from the extracted signals and may determine the reference pressure value 731 of the first reference signals 250. The mode means a value that appears most. For example, a mode “0” of signals obtained from the sensor 201 and having values of “0, 0, 0, 5, and 0” is determined as a reference pressure value, and a mode “0” of signals obtained from the sensor 202 and having values of “0, 0, 0, 5, and 5” is determined as a reference pressure value, respectively. The reference pressure value 731 of the first reference signals 250 may be determined by determining the reference pressure values of the signals forming the first reference signals 250.

Also, the reference pressure value 731 of the first reference signals 250 may be determined by using signals obtained from the sensors 301 to 312 in the same way as the above. When there are multiple modes of the first reference signals 250, one of the modes may be determined as a reference pressure value, and when there is no mode, any one of the extracted first reference signals 250 may be determined as a reference pressure value. However, the method of determining the reference pressure value is not limited thereto and may vary. Also, the reference pressure value 731 of the first reference signals 250 may be determined by using a mean or median, but the method of determining the reference pressure value is not limited thereto.

Also, when the device 100 is, for example, a flexible display device, the first reference signals 250 may be obtained from the side detector 120 including an electrostatic touch screen. In this case, the device 100 may obtain the first reference signals 250 from the side detector 120 and may set a period for extracting some of the first reference signals 250. For example, five of the first reference signals 250 may be extracted per second by setting the period, that is, five seconds, and the reference pressure value 731 of the first reference signals 250 of the device 100 may be determined by using the extracted first reference signals 250. The period may be predetermined. For example, the device 100 may extract five signals having values of “5, 1, 5, 10, 10” from among signals obtained by a sensor 308 included in the side detector 120.

Also, the device 100 may determine the reference pressure value 731 of the first reference signals 250 based on the extracted signals. For example, the device 100 determines a mean of the extracted signals as a reference pressure value and may determine the reference pressure value 731 of the first reference signals 250. An arithmetic mean may be used to calculate the mean, but is not limited thereto. For example, a mean “6.2” of the signals having values of “5, 1, 5, 10, 10” and obtained from the sensor 308 included in the side detector 120 may be determined as the reference pressure value 731. Also, the reference pressure value 731 of the first reference signals 250 may be determined by using a mode or median, but the method of determining the reference pressure value is not limited thereto.

Referring to FIG. 7, the device 100 may obtain the second reference signals 650 from the front detector 140 arranged on the front portion of the device 100. In this case, the device 100 may obtain the second reference signals 650 from the front detector 140 and may set a period for extracting some of the second reference signals 650. For example, five of the second reference signals 650 may be extracted per second by setting the period, that is, five seconds, and a reference pressure value 732 of the second reference signals 650 of the device 100 may be determined by using the extracted second reference signals 650. The period may be predetermined. For example, the device 100 may extract five signals having values of “0, 10, 15, 5, and 0” from among signals obtained by a sensor 650 included in the front detector 140.

Also, the device 100 may determine the reference pressure value 732 of the second reference signals 650 based on the extracted signals. For example, the device 100 determines the reference pressure value 732 of the second reference signals 650 by determining a mean of the extracted signals as the reference pressure value 732 of the second reference signals 650. An arithmetic mean may be used to calculate the mean, but is not limited thereto. For example, a mean “6” of the signals having values of “0, 10, 15, 5, and 0” and obtained from the sensor 600 may be determined as the reference pressure value 732 of the second reference signals 650. Also, the reference pressure value 732 of the second reference signals 650 may be determined by using a mode or median, but the method of determining the reference pressure value is not limited thereto.

The device 100 may determine the reference pressure value 730 as the pressure reference when the user grips the device 100 by combining the reference pressure value 731 of the first reference signals 250 and the reference pressure value 732 of the second reference signals 650

In some exemplary embodiments, the device 100 may determine reference pressure values according to grip forms of the user.

For example, the device 100 may determine a grip form of the user based on the first reference signals 250 and the second reference signals 650 forming the reference pressure values and may classify and store the first reference signals 250 and the second reference signals 650, depending on grip forms of the user, which differ depending on the first reference signals 250 and the second reference signals 650. For example, a left-hand reference pressure value is determined by using the first reference signals 250 and the second reference signals 650 which have a left-hand grip form, and a right-hand reference pressure value is determined by using the first reference signals 250 and the second reference signals 650 which have a right-hand grip form, and thus, the reference pressure values may be determined.

For example, when the user grips the device 100, the device 100 may determine grip forms of the user, and according to the grip forms, a level of the pressure on the device 100 may be determined by using reference pressure values having the same grip form from among the reference pressure values.

For example, when the user grips the device 100 with his/her left hand, the device 100 may determine a grip form of the user based on the first signals 200, the second signals 600, and the reference pressure values. When it is determined that the grip form is a left-hand grip form, the device 100 may determine grip forms according to the first reference signals 250 and the second reference signals 650 by using the first reference signals 250 and the second reference signals 650 and may determine left-hand reference pressure value based on the first reference signals 250 and the second reference signals 650 which have the left-hand grip form. Also, the level of pressure on the device 100 may be determined based on the determined left-hand reference pressure value. For example, the level of pressure on the device 100 may be determined by comparing the left-hand reference pressure value with the first signals 200 and the second signals 600.

In some exemplary embodiments, the device 100 may determine reference pressure values according to users who grip the device 100.

For example, the device 100 may classify and store the first reference signals 250 and the second reference signals 650 forming the reference pressure value according to the users and may determine reference pressure values according to the users based on the first reference signals 250 and the second reference signals 650.

For example, the device 100 may determine a reference pressure value with respect to a user A based on the first reference signals 250 and the second reference signals 650 which are obtained only when the user A grips the device 100. Also, when the user A grips the device 100, the device 100 may determine the level of pressure on the device 100 by comparing a reference pressure value with respect to the user A with the first signals 200 and the second signals 600.

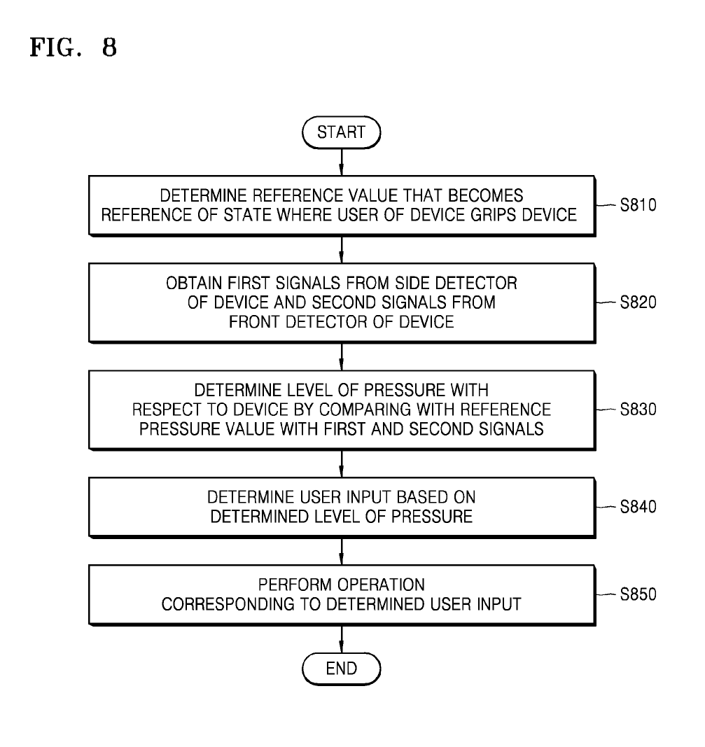

FIG. 8 is a flowchart for explaining a method of controlling the device 100 through gripping pressure of a user.

In operation S810, the device 100 determines a reference pressure value as a pressure reference when the user grips the device 100. The reference pressure value may be determined “on the fly” or may be determined by reading a pre-stored reference pressure value from the storage 160.

In operation S820, the device 100 obtains first signals 200 from the side detector 120 of the device 100 and second signals 600 from the front detector 140.

In some exemplary embodiments, the method may further include obtaining input manipulation signals to set a point in time when the device 100 obtains the first signals 200 and the second signals 600. The input manipulation signals are used to set a start point when the first signals 200 and the second signals 600 start to be obtained or start and end points in order to obtain the first signals 200 and the second signals 600 and may be obtained from, for example, the side detector 120, the front detector 140, or a combination thereof. Also, the input manipulation signals may be obtained from, for example, an actual button disposed outside the device 100, but obtaining the input manipulation signals is not limited thereto and may vary.

In some exemplary embodiments, the device 100 is used to set start and end points, when the first signals 200 and the second signals 600 are obtained, by using the input manipulation signals and may obtain the first signals 200 and the second signals 600.

In operation S830, the device 100 determines pressure on the device 100 by comparing the reference pressure value with the first signals 200 and the second signals 600.

In some exemplary embodiments, the device 100 may determine various levels of pressure, pressure patterns, or a combination thereof according to the first signals 200 and the second signals 600 by comparing the reference pressure value with the first signals 200 and the second signals 600.

In operation S840, the device 100 determines a user input based on the determined level of the pressure.

In some exemplary embodiments, the device 100 may determine a user input based on the level of pressure on the device 100, pressure patterns, or a combination thereof. For example, the device 100 may determine that a certain user input has been received when the determined level of the pressure and pressure patterns are compared with a level of pressure and pressure pattern for the certain user input. In such a case, when the determined pressure level and pressure pattern correspond to the level of pressure and pressure pattern for the certain user input, the certain user input is determined to have been received.

In operation S850, the device 100 performs an operation corresponding to the user input in accordance with the determined user input.

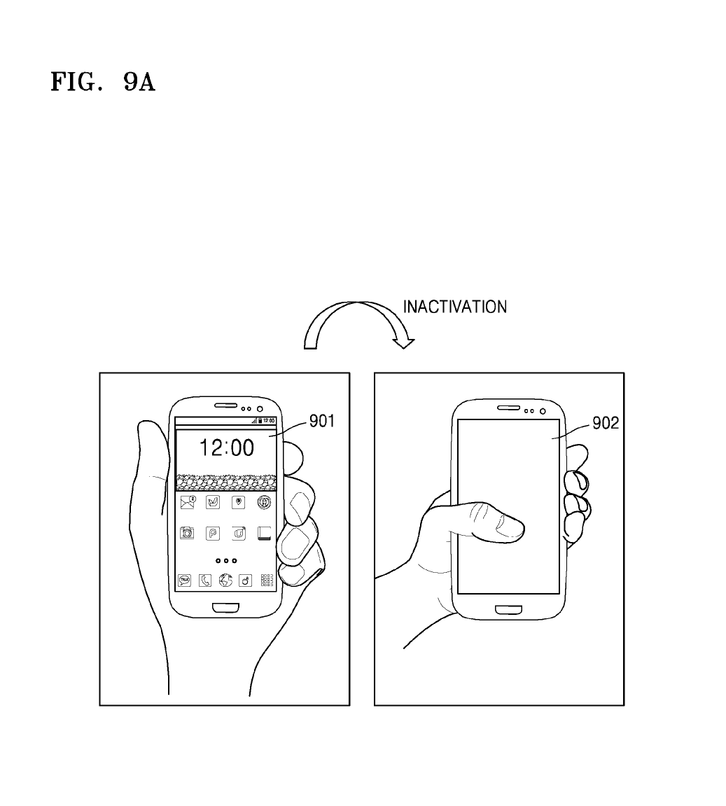

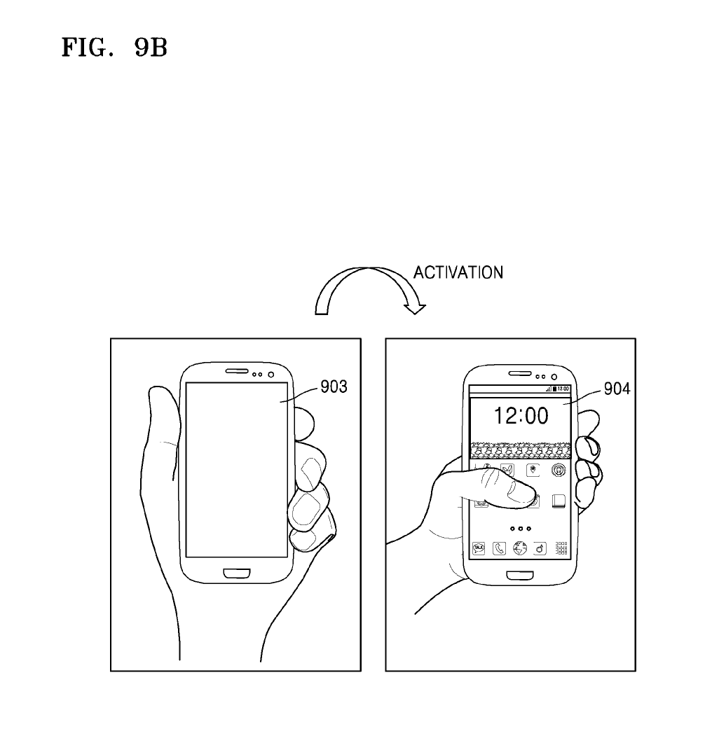

FIGS. 9A and 9B are views for explaining a method of controlling the device 100 through gripping pressure.

FIG. 9A is a view for explaining a controlling method in which an active state of the device 100 is changed to an inactive state through gripping pressure.

FIG. 9A illustrates a screen 901 showing that the user grips the device 100 of which a display is activated. In this case, the user sets a period on the device 100 through a user interface, and the device 100 may extract signals received from the side detector 120 and the front detector 140 of the device 100 as signals for determining a reference pressure value. The period may be predetermined. For example, the device 100 extracts the signals received from the side detector 120 and the front detector 140 of the device 100 as signals for determining the reference pressure value and may determine the reference pressure value as the pressure reference when the user grips the device 100 based on the extracted signals ‘from a point in time when the device 100 is initialized to the present time’. After the reference pressure value is determined, when gripping pressure of the user increases, the device obtains the first signals 200 and the second signals 600 and may determine a level of the gripping pressure by comparing the reference pressure value with the first signals 200 and the second signals 600. When it is determined that the determined level of the gripping pressure is “a first high pressure”, the device 100 determines that a user input for inactivation has been received and may perform an operation of changing a state of a display of the device 100 to an inactive state. As the user applies pressure to the device 100, a screen 902, on which the display is inactivated, may be displayed.

FIG. 9B is a view for explaining a controlling method in which the inactive state of the device 100 is changed to the active state through gripping pressure.

FIG. 9B illustrates a screen 903 showing that the user grips the device 100 having a display that is in an inactive state. In this case, the user sets a period on the device 100 through a user interface, and the device 100 may extract the signals received from the side detector 120 and the front detector 140 of the device 100 as the signals for determining a reference pressure value and may determine the reference pressure value as the pressure reference when the user grips the device 100 based on the extracted signals. The period may be predetermined. After the reference pressure value is determined, when the gripping pressure of the user increases, the device 100 obtains the first signals 200 and the second signals 600 and may determine a level of the gripping pressure by comparing the reference pressure value with the first signals 200 and the second signals 600. When it is determined that the determined level of the gripping pressure is “a first high pressure”, the device 100 determines that a user input for activation has been received and may perform an operation of changing a state of the display of the device 100 to an active state. As the user applies pressure to the device 100, a screen 904, on which the display is activated, may be displayed.

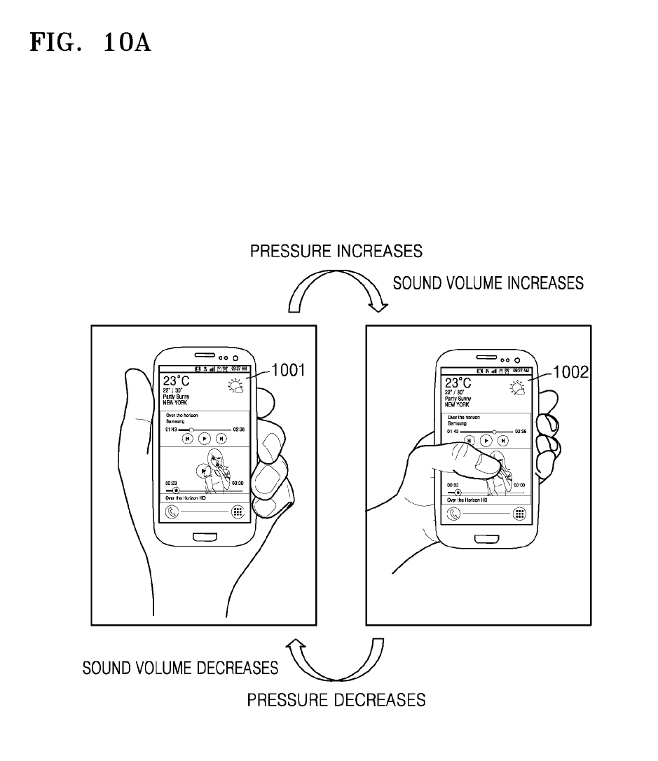

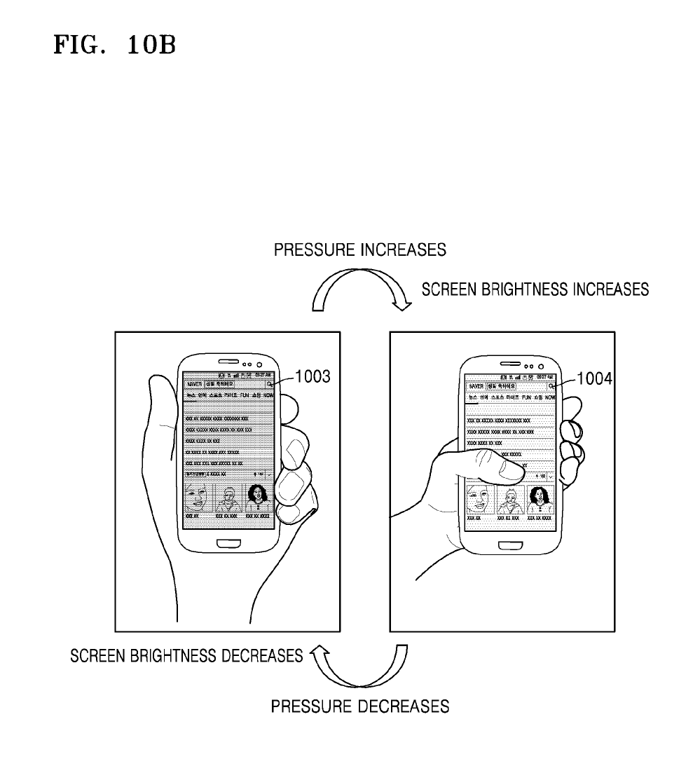

FIGS. 10A and 10B are views for explaining a method of controlling the device 100 through gripping pressure.

FIG. 10A is a view for explaining a method of controlling a volume of music being played by the device 100 through gripping pressure of the user.

FIG. 10A illustrates a screen 1001 showing that the user grips the device 100 that is playing music. In this case, the user sets a period on the device 100 through a user interface, and the device 100 may extract signals received from the side detector 120 and the front detector 140 of the device 100 as signals for determining a reference pressure value. The period may be predetermined. For example, the device 100 may receive a user input through ‘a user interface including a setting button’ and by extracting the signals, which are received from the side detector 120 and the front detector 140 ‘for several seconds (for example, five seconds) from a point in time when the user input is received’, as the signals for determining the reference pressure value, may determine the reference pressure value as a reference of pressure applied when the user grips the device 100 based on the extracted signals. After the reference pressure value is determined, when the gripping pressure of the user increases, the device obtains the first signals 200 and the second signals 600 and may determine a level of the gripping pressure by comparing the reference pressure value with the first signals 200 and the second signals 600. When it is determined that the determined level of the gripping pressure is “a first high pressure”, the device 100 determines that a user input for increasing volume has been received and may perform an operation of increasing the volume of music being played.

Also, when it is determined that the determined level of the gripping pressure is “a second high pressure”, the device 100 may perform an operation of rapidly increasing the volume of the music being played. Also, when it is determined that the determined level of the gripping pressure is “a first low pressure”, the device 100 may perform an operation of decreasing the volume of the music being played. When it is determined that the determined level of the gripping pressure is “a second low pressure”, the device 100 may perform an operation of rapidly decreasing the volume of the music being played, in which case a screen 1002 is displayed.

FIG. 10B illustrates a view for explaining a method of controlling a screen brightness of the device 100 through gripping pressure of the user.

FIG. 10B illustrates a screen 1003 showing that the user grips the device 100 in an active state. In this case, the user sets a period on the device 100 through a user interface, and the device 100 extracts the signals received from the side detector 120 and the front detector 140 as signals for determining the reference pressure value during the period and may determine the reference pressure value as a gripping pressure reference of the user gripping the device 100 based on the extracted signals. The period may be predetermined. After the reference pressure value is determined, when the gripping pressure of the user increases, the device 100 obtains the first signals 200 and the second signals 600 and may determine a level of the gripping pressure by comparing the reference pressure value with the first signals 200 and the second signals 600. When it is determined that the determined level of the gripping pressure is “a first high pressure”, the device 100 determines that a user input for increasing screen brightness has been received and thus may perform an operation of increasing the screen brightness. Also, when it is determined that the determined level of the gripping pressure is “a second high pressure”, the device 100 may perform an operation of rapidly increasing the screen brightness. Also, when it is determined that the determined level of the gripping pressure is “a first low pressure”, the device 100 may perform an operation of decreasing the screen brightness. When it is determined that the determined level of the gripping pressure is “a second low pressure”, the device 100 may perform an operation of rapidly decreasing the screen brightness.

The one or more exemplary embodiments of the inventive concept can be written as computer programs and can be implemented in general-use digital computers that execute the programs using a computer-readable recording medium. The computer-readable recording medium is a medium capable of being accessed by a computer and includes at least one of a volatile medium, a non-volatile medium, a removable medium, and a non-removable medium. Also, the computer-readable recording medium may also include a computer storage medium and communication medium. The computer-readable recording medium includes a volatile medium, a non-volatile medium, a removable medium, and a non-removable medium which are implemented by an arbitrary method or technology so as to store computer-readable instructions, data structures, program modules, or other data. The communication medium generally includes computer-readable instructions, data structures, program modules, or data having modulated data signals, or other transmission mechanisms and also includes an information transmission medium.

One or more exemplary embodiments of the inventive concept have been described. It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of measuring pressure on a device, the method comprising:
determining a reference pressure value of a grip of user on the device;
obtaining first signals from a side detector of the device;
obtaining second signals from a front detector of the device; and
determining a level of pressure on the device by comparing the first signals and the second signals with the reference pressure value.

2. The method of claim 1, wherein the determining of the reference pressure value comprises determining the reference pressure value when the user using the device grips the device by:
obtaining first reference signals from the side detector during a first reference period;
obtaining second reference signals from the front detector during a second reference period; and
determining the reference pressure value with respect to the user of the device, based on the obtained first reference signals and the obtained second reference signals.

3. The method of claim 1, wherein the obtaining of the first signals comprises obtaining a plurality of signals, from a plurality of sensors, respectively, comprised in the side detector, as the first signals, and
the obtaining of the second signals comprises obtaining second signals comprising touch signals, hovering signals, or a combination of the touch signals and the hovering signals which are input to a left edge and a right edge of the front detector of the device, as the second signals.

4. The method of claim 1, wherein the determining of the reference pressure value comprises:
setting a reference period;
obtaining a plurality of first reference signals from the side detector of the device during the reference period;
obtaining a plurality of second reference signals from the front detector of the device during the reference period; and
determining the reference pressure value based on the plurality of first reference signals and the plurality of second reference signals.

5. The method of claim 1, wherein the determining of the level of the pressure comprises determining pressure patterns with respect to the device according to the first signals and the second signals by comparing the first signals and the second signals with the reference pressure value.

6. The method of claim 1, wherein the determining of the level of the pressure comprises determining a grip form in which the user grips the device, based on the reference pressure value, the first signals, and the second signals.

7. The method of claim 1, further comprising:
determining a user input based on the determined level of the pressure; and
performing operations corresponding to the determined the user input.

8. The method of claim 7, wherein the determining of the level of the pressure comprises determining pressure patterns with respect to the device by comparing the first signals and the second signals with the reference pressure value.

9. The method of claim 7, further comprising:
obtaining an input manipulation signal for setting periods for obtaining the first signals and the second signals,
wherein the first signals and the second signals are obtained during the periods that are set according to the input manipulation signal.

10. A non-transitory computer-readable recording medium having embodied thereon a program, which when executed by a computer, for performing a method comprising:
determining a reference pressure value of a grip of user on the device;
obtaining first signals from a side detector of the device;
obtaining second signals from a front detector of the device; and
determining a level of pressure on the device by comparing the first signals and the second signals with the reference pressure value.

11. A device comprising:
a side detector arranged on a side portion of the device and configured to obtain first signals;
a front detector arranged on a front portion of the device and configured to obtain second signals; and
a controller configured to determine a reference pressure value of a grip of a user on the device and to determine a level of the pressure on the device by comparing the first signals and the second signals with the reference pressure value.

12. The device of claim 11, wherein the side detector is configured to obtain first reference signals during a first reference period,
the front detector is configured to obtain second reference signals during a second reference period, and
the controller is configured to determine of the reference pressure value with respect to the user using the device, based on the first reference signals and the second reference signals.

13. The device of claim 11, wherein the side detector comprises a plurality of sensors arranged on a left side portion and a right side portion of the device in an array form and configured to obtain a plurality of signals from the plurality of sensors, respectively, as the first signals, and
the front detector is configured to obtain a plurality of second signals comprising touch signals, hovering signals, or a combination of the touch signals and the hovering signals which are input to a left edge and a right edge of the device, as the second signals.

14. The device of claim 11, wherein the side detector is configured to obtain a plurality of first reference signals during a reference period,
the front detector is configured to obtain a plurality of second reference signals during the reference period,
the device further comprises a storage configured to store the plurality of first reference signals and the plurality of second reference signals, and
the controller is configured to set the reference period for determining the plurality of first reference signals and the plurality of second reference signals as references for determining the reference pressure value, and to determine the reference pressure value based on the plurality of first reference signals and the plurality of second reference signals, which are obtained during the reference period.

15. The device of claim 11, wherein the controller is configured to determine pressure patterns with respect to the device by comparing the first signals and the second signals with the reference pressure value.

16. The device of claim 11, wherein the controller is configured to determine a grip form in which the user grips the device, based on the reference pressure value, the first signals, and the second signals.

17. The device of claim 11, wherein the controller is further configured to determine a user input based on the determined level of the pressure on the device, and perform operations corresponding to the determined user input.

18. The device of claim 17, wherein the controller is configured to determine pressure patterns with respect to the device by comparing the first signals and the second signals with the reference pressure value.

19. The device of claim 17, wherein the side detector or the front detector is configured to obtain an input manipulation signal for setting a period for obtaining the first signals and the second signals.

20. The method of claim 1, wherein the determining of the reference pressure value comprises reading the reference pressure value from a storage.

21. The method of claim 2, wherein the first reference period is the same as the second reference period.

22. The method of claim 7, wherein the determining of the reference pressure value comprises reading the reference pressure value from a storage.

23. The device of claim 11, wherein the controller determines the reference pressure value by reading the reference pressure value from a storage.

24. The device of claim 12, wherein the first reference period is the same as the second reference period.

25. A method of controlling a device based on a grip pressure of a user on the device, the device comprising a plurality of pressure sensors, each sensor located at a different location on the device, the method comprising:
obtaining pressure signals from the plurality of pressure sensors during a time at which a user grips the device;
comparing the pressure signals with a previously-set reference pressure signal associated with the user;
controlling the device based on a result of the comparison.

26. The method of claim 25, wherein obtaining the pressure signals comprises determining a grip form of the user,
wherein the device is controlled based on the grip form.

27. The method of claim 25, wherein obtaining the pressure signals comprises determining a pressure pattern of the grip of the user,
wherein the device is controlled based on the pressure pattern.
